(19) United States
(12) Patent Application Publication
(10) Pub. No.: US 2005/0128767 A1
(43) Pub. Date: Jun. 16, 2005

(54) Light source structure of light emitting diode

(76) Inventors: Bily Wang, Hsin Chu City (TW); Jonnie Chuang, Pan Chiao City (TW); Chi-Wen Hung, Chung Li City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/731,097

(22) Filed: Dec. 10, 2003

(51) Int. Cl. F21V 7/04

(52) U.S. Cl. 362/555

(57) ABSTRACT

A light source structure for a light emitting diode (LED) has a high modulating flexibility and a low manufacturing cost. The LED light source is a white light source for an electrical device. The LED light source structure is used to meet the illumination requirement of the electrical device and the benefit from the light source structure of LED is more modulating ability with a small volume. The Led light source structure has an electrical circuit substrate, a red light LED chip, a green light LED chip, a blue light LED chip, a controlling integral circuit chip and a certain shape of packaging material.

### FIELD OF THE INVENTION

The present invention relates to a light source structure of a light emitting diode (LED) to be applied on the requirement field of white light. The light source structure has a high modulating ability and a low manufacturing cost. The present invention uses the LED as the light source for an electrical device. The present invention provides an increased modulating ability together with a small volume, when compared with a conventional light source.

### BACKGROUND OF THE INVENTION

A white light source is widely required in various kinds of electrical devices, as is known by persons familiar with the related industrial field. A white light source LED has the benefit of small volume for practical application when compared with the conventional method of RGB (red, green blue) LED lighting. In particular, the white light source can replace part of the conventional RGB LED in a scanner, a fax machine, a mobile phone, a PDA and an LCD monitor. The white light source is thus a very promising and competitive field for research.

FIG. 1 illustrates a schematic, cross-sectional view of a conventional white light LED 1. The light source is a blue light LED chip 12. In the application of the conventional white light LED 1, the blue light LED chip 12 is packaged in the packaging material 16 with the yellow fluorescent powder 14. When the blue light LED chip 12 is illuminated, the yellow fluorescent powder 14 absorbs a part of the blue light to radiate yellow light. After the blue light and the yellow light mix, the white light is generated.

Thus the conventional technique to generate white light requires a blue light LED chip 12 and yellow fluorescent powder 14. Yellow fluorescent powder 14, however, cannot be reliable obtained at a steady price. The manufacturing cost of the conventional white light LED is not low enough for a common electrical component. Another drawback of the present invention is that the color temperature of the white light LED is restricted to a narrow range.

FIG. 2 illustrates another conventional RGB LED light source provided by the method of mixing light to generate the white light. The RGB mixing light LED 2 uses an outer electrical circuit to control the color temperature thereof. The red light controller 21 is used to control the red light LED chip 26, the green light controller 22 is used to control the green light LED chip 27, and the blue light controller 23 is used to control the blue light LED chip 28. Each controller 21, 22, 23 can control the color temperature of respective LED chip 26, 27, 28. To summarize the above structure, the method of the second conventional technique can easily control the color temperature. But the second conventional technique requires too large space for settlement of the outer controlling electrical circuit. Thus the manufacturing cost is raised.

Most light sources for current electrical devices on the market require small size together with a high degree of color temperature control. Thus the present invention is provided to resolve these problems.

### SUMMARY OF THE INVENTION

The main purpose of the present invention is to provide a light source structure with small volume and a color temperature modulating ability. Thus the present invention is sufficiently high in quality and cheap to meet the light source requirement of office machines or other electrical devices.

In order to reach the above purpose, the present invention provides a light source that uses the RGB LED chips as the main structure, mates the same with a total controlling IC (integrated circuit) chip, and finally packages all the components to finish the present invention.

The present invention comprises an electrical circuit substrate having electrical circuits thereon. A red light LED chip is installed on the electrical circuit substrate, the red light LED chip being electrically connected to part of the electrical circuits. A green light LED chip is installed on the electrical circuit substrate, the green light LED chip being electrically connected to part of the electrical circuits. A blue light LED chip is installed on the electrical circuit substrate, the blue light LED chip being electrically connected to a part of the electrical circuits. A controlling integral circuit chip is installed on the electrical circuit substrate, the controlling integral circuit chip being electrically connected to a part of the electrical circuits, and the controlling integral circuit chip being electrically connected to predetermined red light, green light, and blue light LED chips. A certain shape of packaging material is used to package the red light, the green light, and the blue light LED chips and the controlling integral circuit chip, with the packaging material packaging the predetermined chips into one body.

### BRIEF DESCRIPTION OF DRAWINGS

The various objects and advantages of the present invention will be more readily understood from the following detailed description when read in conjunction with the appended drawing, in which:

FIG. 1 shows a schematic sectional view of a first conventional technique;

FIG. 2 shows a schematic view of a second conventional technique;

FIG. 3 shows a schematic view of an electrical circuit of the present invention; and

FIG. 4 shows a schematic top view of structure of the present invention.

### DETAILED DESCRIPTION OF THE INVENTION

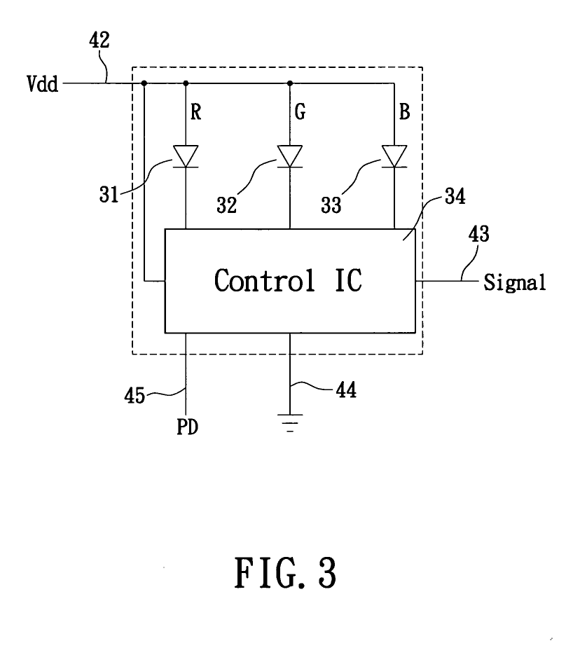

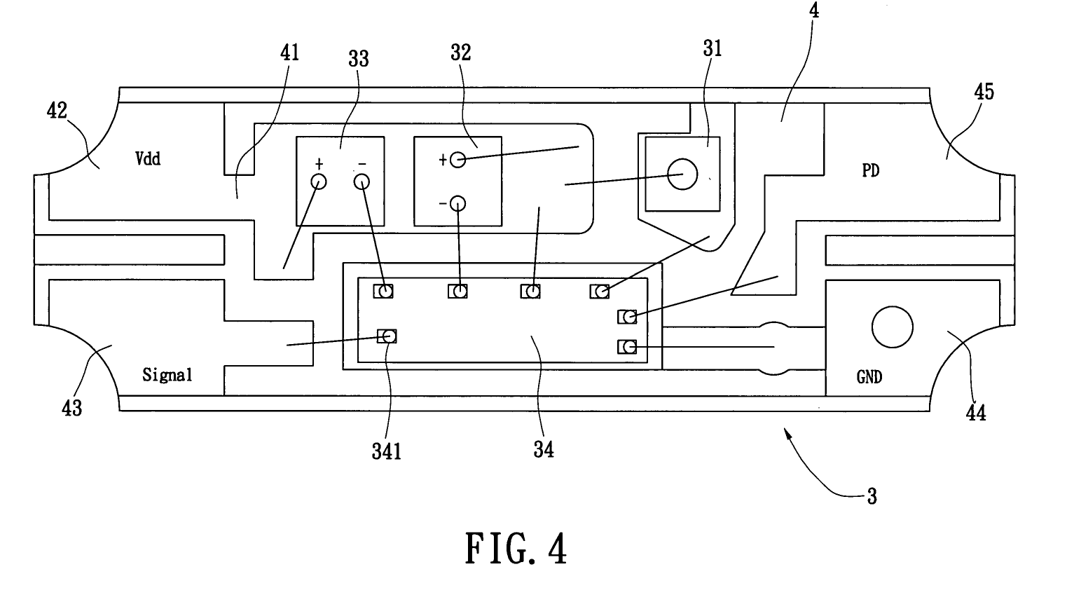

Reference is made to FIGS. 3 and 4, which illustrate the structure of the present invention. The light source structure of the light emitting diode 3 of the present invention comprises many components. Firstly, the present invention comprises an electrical circuit substrate 4 having the electrical circuit 41. The electrical circuit substrate 4 can use the conventional LED substrate for convenience. The major consideration of the electrical circuit substrate 4 is that space be conserved when receiving the electrical circuit 41 and the electrical chip components. Secondarily, the present invention comprises a red light LED chip 31 installed on the electrical circuit substrate 4. The red light LED chip 31 is electrically connected to a part of the electrical circuits 41. A green light LED chip 32 is installed on the electrical circuit substrate 4, the green light LED chip 32 being electrically connected to a part of the electrical circuits 41. A blue light LED chip 33 is installed on the electrical circuit substrate 4, the blue light LED chip 33 being electrically connected to a part of the electrical circuits 41. Thirdly, the present invention comprises a controlling integral circuit chip 34 installed on the electrical circuit substrate 4, the controlling integral circuit chip 34 being electrically connected to a part of the electrical circuits 41, the controlling integral circuit chip being electrically connected to predetermined LED chips of the red light LED chip 31, the green light LED chip 32, and the blue light LED chip 33. Finally, the present invention further comprises a certain shape of packaging material to package the red light LED chip 31, the green light LED chip 32, the blue light LED chip 33 and the controlling integral circuit chip 34, the packaging material packaging the predetermined chips into one body.

The electrical connection between the many components depends on the metal wire bonding to actuate each function of the components. For example, the power actuation location 42 represents the positive power source, from the connection by the metal wire bonding to connect to the positive electrode of the blue light LED chip 33. From the inference to the similar condition in the invention, the negative electrode of the blue light LED chip 33 is electrically connected to one electrical connection node 341 of the controlling integral circuit chip 34.

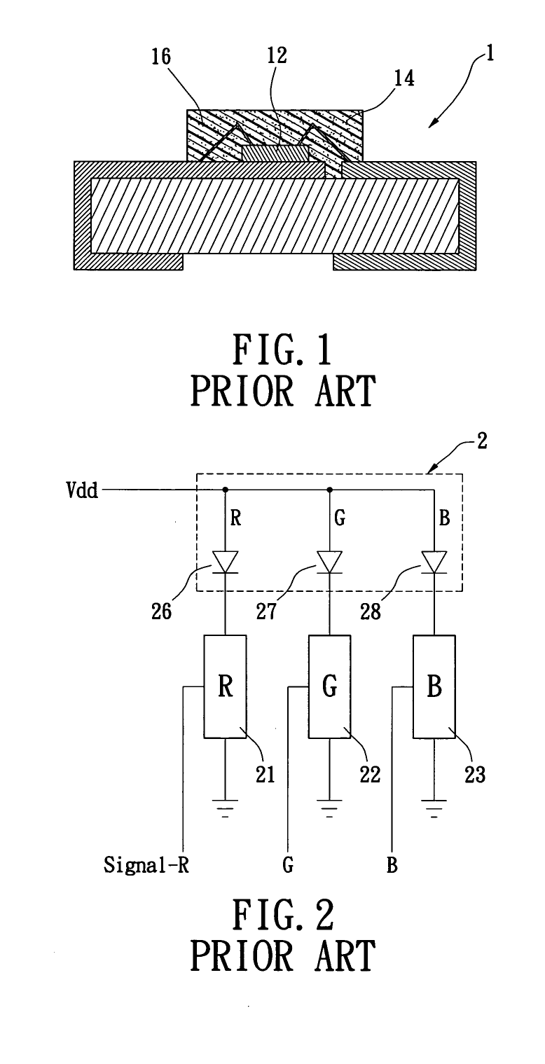

The feature and the convenience of the present invention are to package the LED controllers together with the LED chips to reduce the size of the light source. Also, the modulating ability of the color temperature is higher than that provided by the first conventional technique in the FIG. 1, which only uses the yellow fluorescent powder 14 to generate the white light by light mixing.

Variations in the preferred embodiment are described as follows. The controlling integral circuit chip 34 can be designed to have 7 electrical connection nodes 341 as R, G, B, Vdd, Signal, Gnd, and PD. For practical requirement, the controlling integral circuit chip 34 can be designed to have at least 5 electrical connection nodes 341 as R, G, B, Vdd, Gnd . . . etc. Thus the controlling integral circuit chip 34 can have a plurality of electrical connection nodes 341 with a quantity ranging from 5 to 9. In addition, the light source structure of the light emitting diode 3 has a package with 4 electrical connection locations with the names of: Vdd, Signal, PD, and Gnd. Again for practical requirement, the light source structure of the light emitting diode 3 can be designed to have at least 2 electrical connection locations with the names of: Vdd, Gnd . . . etc. Thus the light source structure of the light emitting diode 3 can have a plurality of electrical connection locations on the package with a quantity ranging from 2 to 8. The package of the light source structure of the light emitting diode can have 4 electrical connection locations, a power actuation location 42, a control signal location 43, a grounding location 44, and a function reserving location 45. Each electrical connection location connects to a part of the electrical circuits. Further, the package with 2 to 8 electrical connection locations is conformed to surface mount technology (SMT) to be installed on the printed circuit board. The controlling integral circuit chip 34 receives the control signal from the control signal location to modulate the color temperature of all the LED chips in the package, comprising red light LED chip 31, green light LED chip 32, and blue light LED chip 33. The function reserving location can be electrically connected to an outer photo diode to monitor the color temperature thereof.

Although the present invention has been described with reference to the preferred embodiment thereof, it will be understood that the invention is not limited to the details thereof. Various substitutions and modifications have suggested in the foregoing description, and others will occur to those of ordinary skill in the art. Therefore, all such substitutions and modifications are intended to be embraced within the scope of the invention as defined in the appended claims.

1. A light source structure of light emitting diode, comprising:
an electrical circuit substrate having electrical circuits thereon;
a red light LED chip installed on the electrical circuit substrate, the red light LED chip being electrically connected to part of the electrical circuits;
a green light LED chip installed on the electrical circuit substrate, the green light LED chip being electrically connected to part of the electrical circuits;
a blue light LED chip installed on the electrical circuit substrate, the blue light LED chip being electrically connected to a part of the electrical circuits;
a controlling integral circuit chip installed on the electrical circuit substrate, the controlling integral circuit chip being electrically connected to part of the electrical circuits, and the controlling integral circuit chip being electrically connected to predetermined LED chips of the red light LED chip, the green light LED chip, and the blue light LED chip; and
a certain shape of packaging material to package chips of the red light LED chip, the green light LED chip, the blue light LED chip and the controlling integral circuit chip, the packaging material packaging the predetermined chips into one body.

2. The light source structure of the light emitting diode as claimed in claim 1, wherein the controlling integral circuit chip has about 5 to 9 electrical connection nodes.

3. The light source structure of the light emitting diode as claimed in claim 2, wherein the controlling integral circuit chip has about 7 electrical connection nodes.

4. The light source structure of the light emitting diode as claimed in claim 1, wherein the light source structure of the light emitting diode has a package with about 2 to 8 electrical connection locations.

5. The light source structure of the light emitting diode as claimed in claim 4, wherein the light source structure of the light emitting diode has a package with about 4 electrical connection locations.

6. The light source structure of the light emitting diode as claimed in claim 5, wherein the package of light source structure of the light emitting diode has 4 electrical connection locations, including a power actuation location, a control signal location, a grounding location, and a function reserving location, each of the 4 electrical connection locations connecting to a part of the electrical circuits.

7. The light source structure of the light emitting diode as claimed in claim 4, wherein the package with about 2 to 8 electrical connection locations conforms to surface mount technology (SMT) to be installed on a printed circuit board.

8. The light source structure of the light emitting diode as claimed in claim 6, wherein the controlling integral circuit chip receive the control signal from the control signal location to modulate the color temperature of all the LED chips in the package, comprising the red light LED chip, the green light LED chip, and the blue light LED chip.

9. The light source structure of the light emitting diode as claimed in claim 6, wherein the function reserving location is electrically connected to an outer photo diode.
